(19) United States
(12) Patent Application Publication
(10) Pub. No.: US 2015/0267392 A1
(43) Pub. Date: Sep. 24, 2015

(54) Method for Construction of Concrete Septic Tanks

(71) Applicant: Harry Lee Cormier, Beaumont, TX (US)

(72) Inventor: Harry Lee Cormier, Beaumont, TX (US)

(21) Appl. No.: 14/659,620

(22) Filed: Mar. 17, 2015

Related U.S. Application Data
(60) Provisional application No. 61/955,149, filed on Mar. 18, 2014.

(51) Int. Cl. E03F 5/14; B28B 1/14

(52) U.S. Cl. CPC E03F 5/14; B28B 1/14

(57) ABSTRACT

The disclosed method allows for a septic tank made of a pourable castable material to be constructed with a single continuous pour to create a septic tank with no seams. This method may be practiced at the site of septic tank installation, minimizing the stress on the septic tank that result from being transported to the installation site.

### PRIORITY/CROSS REFERENCE TO RELATED APPLICATION

This application claims priority to Provisional Patent Application No. U.S. 61/955,149 entitled “Method for Construction of Concrete Septic Tanks” by Harry Cormier filed on Mar. 18, 2014. That application is incorporated by reference in its entirety.

### BACKGROUND

A septic tank 1000 is a common item in modern houses that are not connected to large sewerage networks. These septic tanks 1000 need to be able to accommodate and process the volume of waste water generated by users in the house.

Septic tanks 1000 connect to the waste water source via an inlet pipe that enters the septic tank 1000 through an inlet opening 710. Typically there is a baffle 520 (dividing wall) inside the septic tank 1000 that separates the septic tank 1000 into two chambers. The baffle 520 may have a baffle aperture 525 to facilitate water flow between the chambers of the septic tank 1000. The first chamber 590 is where the waste water initially enters, where the solid materials eventually settles to the bottom to be broken down through various means. The remaining waste water flows into the second chamber 595, where further waste eventually settles out before the waste water is discharged though the outlet opening 750 to the outlet pipe into a leech field or other system.

Septic tanks 1000 may be installed above or below the ground. When a septic tank 1000 is installed underground, soil is excavated to make a pit large enough to accommodate the septic tank 1000. The septic tank 1000 is placed in the pit, connected to the waste water feed source, connected to a discharge system, and covered with soil.

Septic tanks 1000 may be made from various materials, including but not limited to steel, plastic, fiberglass, high density polyethylene, or concrete. Concrete septic tanks 1000 have certain advantages over septic tanks 1000 made from other materials. Concrete septic tanks 1000 get stronger over time as the concrete cures. Concrete septic tanks 1000 are not as buoyant as some other septic tank 1000 materials, reducing the need to prepare a site for septic tank 1000 installation. Concrete does not have any known toxic properties. Concrete septic tanks 1000 are also resistant to any damage that may occur during backfill.

### SUMMARY

The disclosed invention relates to a method for constructing a concrete septic tank. The method will allow for standard and customized concrete septic tanks 1000 to be built as the project requires. Concrete septic tanks 1000 of different volumes, numbers of openings, baffles, opening locations, and other details may be accounted for using the method disclosed herein.

The method involves preparing the area to construct the septic tank 1000. A series of frames are placed in the area and are secured. Once the frames are secured, concrete is poured in such a manner that the frame makes the resulting concrete structure becomes a septic tank 1000. Other embodiments utilizing molds accomplishing the same effect.

One of the advantages of this method is the resulting tank is made of a single piece of concrete that can further be sealed with a sealing pour to form one concrete unit. Once the septic tank 1000 is created, it may be used as a normal septic tank 1000.

### BRIEF DESCRIPTION OF FIGURES

FIG. 1 is a flowchart showing an exemplary embodiment of a Frame Pour method 100 in an exemplary embodiment.

FIG. 2 is a flowchart showing an exemplary embodiment of a Mold Pour method 200 in an exemplary embodiment.

FIG. 3 is a flowchart showing an exemplary embodiment of a Lid Pour method 300 in an exemplary embodiment.

FIG. 4 is a perspective drawing of the foundation frame 450, sidewall frame 455, baffle frame 460, headwall frame 475, blocking mold 465, and connector 480 in an exemplary embodiment.

FIGS. 5a-e show the process of pouring the castable material in an exemplary embodiment.

FIG. 6 shows the septic tank 1000 formed in FIG. 5e with the sidewall frame 455, blocking mold 465, and connectors 480 removed in an exemplary embodiment.

FIG. 7 shows the flow of waste water in the resulting septic tank 1000 in an exemplary embodiment.

FIG. 8a is a top down view of the object of FIG. 4 in a pit when a secondary frame 910 is not installed before the concrete pour in an exemplary embodiment.

FIG. 8b is a top down view of the septic tank formed after the concrete pour with the frames removed when a secondary frame 910 is not installed in an exemplary embodiment.

FIG. 9a is a top down view of the object of FIG. 4 in a pit when a secondary frame 910 is installed before the concrete pour in an exemplary embodiment.

FIG. 9b is a top down view of the septic tank formed after the concrete pour with the frames and secondary frame 910 are removed in an exemplary embodiment.

FIG. 10 is a perspective drawing of the septic tank 1000 with the lid 1010 placed above it in an exemplary embodiment.

### DETAILED DESCRIPTION

The exemplary embodiment will describe an in ground concrete septic tank 1000 formed at the installation location as opposed to being transported to the installation location. However, it is understood that the same process may be adapted to above ground concrete septic tanks 1000 or ones formed to be transport later as needed. Further, while concrete is discussed, it may apply to any castable material that may be poured to create structures.

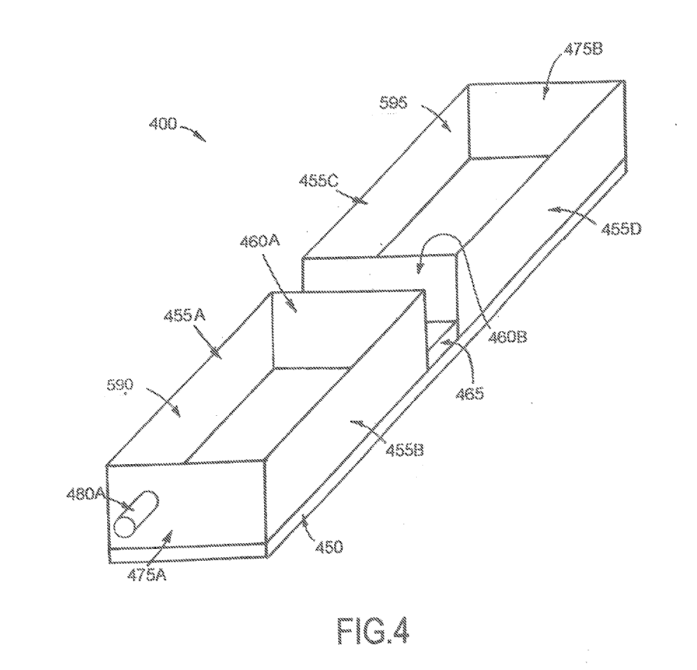

The requirements of the septic tank 1000 determine the steps to be taken. First the size of the septic tank 1000 needs to be established. This may be based on multiple factors, including, but not limited to, number of possible users of the septic tank. Once the size of the septic tank 1000 is determined, then an area is excavated, forming a pit with a pit bottom 515 and pit walls 510, to accommodate the septic tank 1000. A series of frames are then erected within the pit to control the pouring of the concrete. The dimensions of these frames will be determined by how large a septic tank 1000 is needed to accomplish the intended purpose of the septic tank 1000. FIG. 4 provides a visual representation of how such a series of frames would look in an exemplary embodiment when outside of the pit.

Frame Guided Method For Creation of Septic Tank

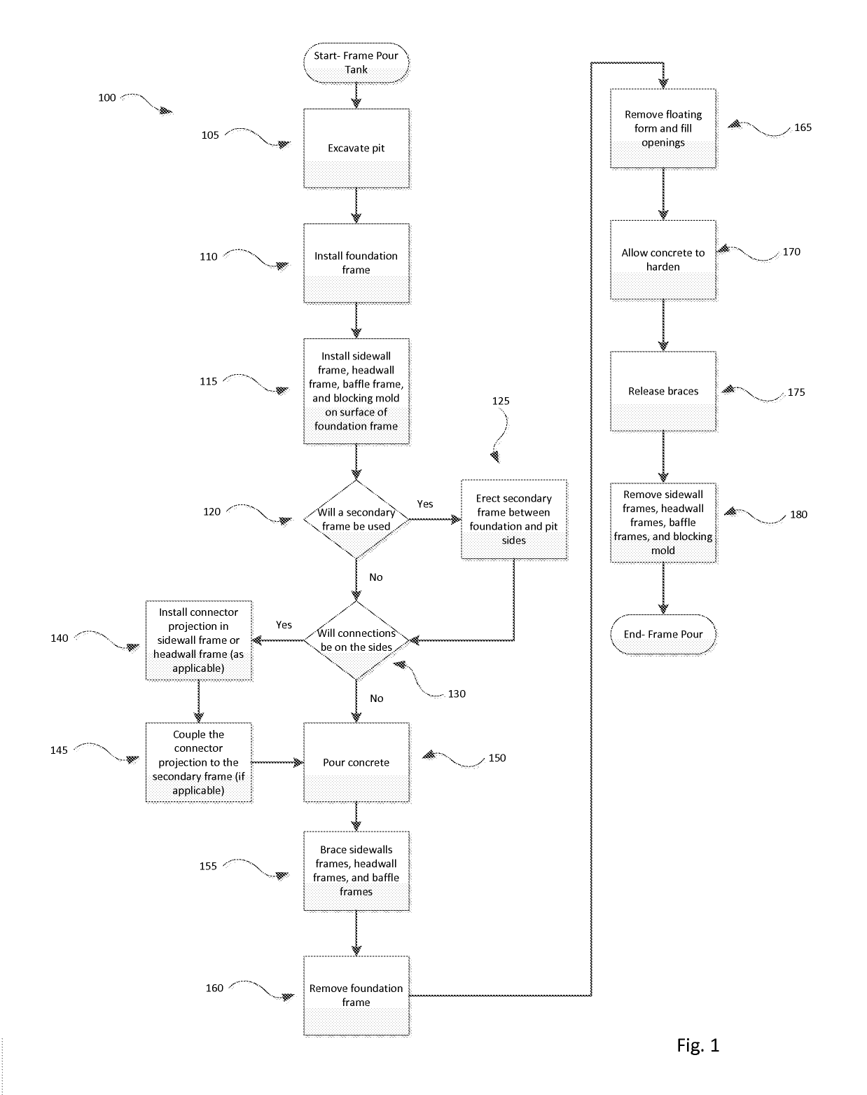

This method is disclosed in FIG. 1 creates a frame poured tank 100. A pit is excavated per the process 105 to accommodate the resulting septic tank 1000. A foundation frame 450 is installed per the process 110 on the pit bottom 515. This foundation frame 450 will rest on supports, known in the trade as a floating form 530, keeping the foundation frame 450 above the surface of the pit bottom 515.

Once the foundation frame 450 is installed per the process 110, the next step per the process 115 involves the installation of the sidewall frames 455, baffle frames 460, and headwall frames 475 adjacent to, if not connected to, the surface of the foundation frame 450. The sidewall frames 455 and headwall frames 475 together are referred to as a primary frame. The sidewall frames 455 are situated at the edge of the foundation frame 450 for a substantial length of the sides of the foundation frame 450. The sidewall frames 455 end at the location where the baffle frames 460 are to be installed. The headwall frames 475 are at the distal ends of the foundation frame 450. The location of the baffle frames 460 may be at any position, but is typically near the mid-point between the headwall frames 475. The baffle frames 460 run parallel to the headwall frames 475. In the exemplary embodiment, the sidewall frames 455, headwall frames 475, and baffle frames 460 couple to the foundation frame 450 at a right angle by any means known to those skilled in the art.

In the exemplary embodiment, there will be a space between the two baffle frames 460. A blocking mold 465 will be located on the foundation frame 450 that will occupy a portion the space between the two baffle frames 460. The blocking mold 465 will be sized to create the necessary baffle aperture 525 in the resulting sceptic tank 1000. The area defined between the two baffle frames 460 will be the area the baffle 520 will form within. The baffle 520 will not completely occupy the space between the baffle frames 460 because the blocking mold 465 will prevent liquid castable material from occupying the area of the baffle aperture 525.

In an exemplary embodiment, there are two ways to define the outer edges of the septic tank 1000. There is a single frame method where the outside of the septic tank 1000 is defined by the coupled sidewall frames 455 and headwall frames 475 with respect to the pit wall 510. There is also the double frame method where the outer edge of the septic tank 1000 is defined by the sidewall frame 455 and headwall frame 475 with respect to a secondary frame 910. Both will be explained in turn.

Frame Guided Method-Single Frame Method

Using the single frame method, there will be no need for a secondary frame 910 per the process 120. The sidewall frames 455 and the headwall frames 475 are positioned to allow for concrete to be poured in the area between the sidewall frames 455 and the pit wall 510 along with the headwall frames 475 and the the pit wall 510, while at the same time allowing the concrete to flow beneath the foundation frame 450. The walls of the septic tank 1000 form between the space defined by the sidewall frames 455 and headwall frames 475 versus the pit walls 510. FIG. 8a shows a top down view of how this embodiment would look before the concrete is poured. FIG. 8b shows a top down view of how this embodiment would look after the concrete is poured.

Frame Guided Method-Double Frame Method

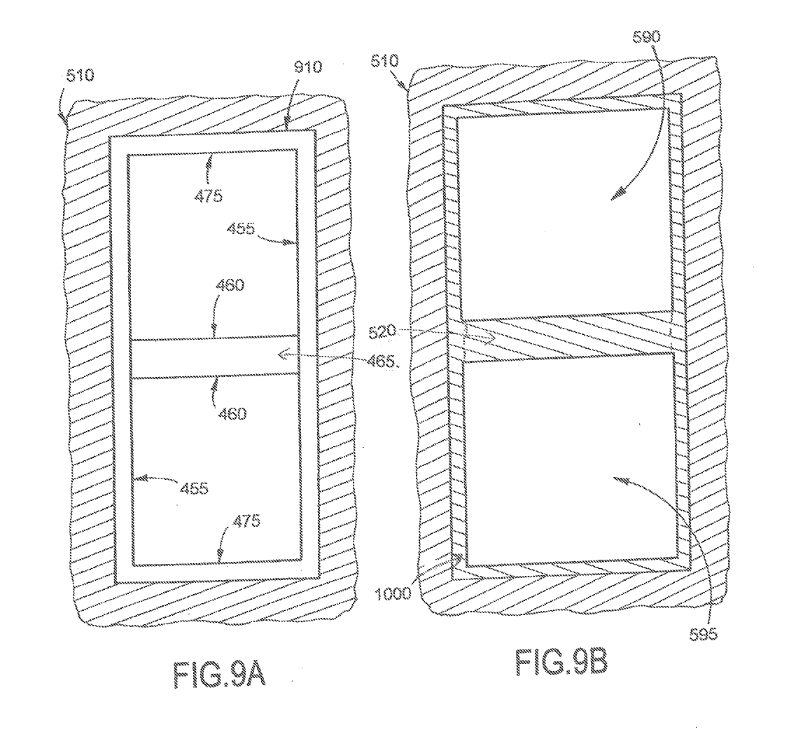

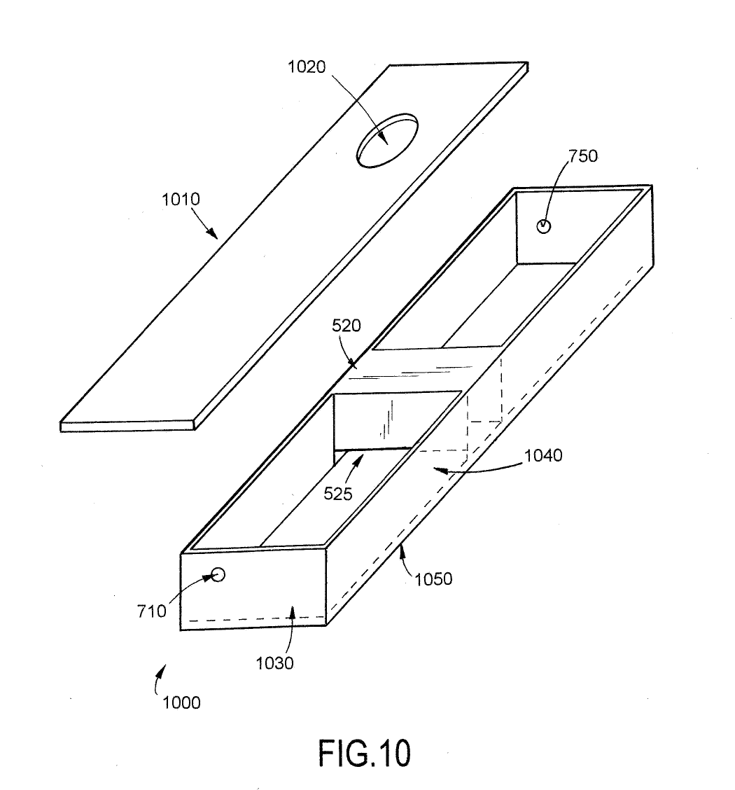

Using the double frame method, a secondary frame 910 is used per the process 120. To use a double frame method, a sidewall frame 455 and headwall frames 475 are used as previously disclosed in the single frame method. A secondary frame 910 is then erected per the process 125 between the combined sidewall frames 455 and headwall frames 475 versus the pit walls 510. This allows the concrete to be poured as previously disclosed in the single frame method, but not to interact with the pit walls 510 directly. The formation of the sides of the septic tank 1000 as an integrated unit is achieved as in the single frame method, but the concrete flow is more carefully controlled. This also allows for builders to interface with the septic tank 1000 before it is covered without excavating more soil. This method may also be used to create an above ground septic tank 1000. FIG. 9a shows a top down view of how this embodiment would look before the concrete is poured. FIG. 9b shows a top down view of how this embodiment would look after the concrete is poured.

Frame Guided Method-Openings

Septic tanks 1000 typically have at least one inlet opening 710 and one outlet opening 750. If the inlet openings 710 and outlet openings 750 are to be on the sides of the septic tank 1000 per the process 130, then the sidewall frame 455 (and secondary frame 910 as applicable) may further comprise projections 480 for the concrete to flow around so that the inlet openings 710 and outlet openings 750 may be maintained for connections during the pour. In an exemplary embodiment utilizing the single frame method, a removable projection 480 will be installed per the process 140 out of the headwall frame 475 where the inlet openings 710 and outlet openings 750 are required. This projection 480 would extend far enough to make sure no concrete blocks the inlet openings 710 and outlet openings 750 when the concrete cures. If the double frame method is used, then the projection 480 would connect the sidewall frame 455 or headwall frame 475 and the secondary frame 910 at the desired inlet opening 710 location and outlet opening 750 per the process 145. Once the concrete has been poured per the process 150 and sufficiently hardened, the projections 480 are to be removed to show the openings.

In an alternative embodiment, the actual inlet pipes and outlet pipes to be used by the septic tank 1000 may be used to form the inlet openings 710 and outlet openings 750 in the place of projections 480. The pipes may be installed, and the sidewall frame 455 or headwall frame 475 may be constructed around them. When the concrete is poured, the concrete will flow around the pipes, creating the openings necessary in the septic tank 1000 for access.

If the inlet openings 710 and outlet openings 750 will be on the top surface of the septic tanks 1000, then no inlet openings 710 and outlet openings 750 will be needed in the sidewalls 1040 or headwalls 1030. The inlet openings 710 and outlet openings 750 may be part of the lid 1010, which will be discussed below. In an exemplary embodiment, the inlet opening 710 is higher than the outlet opening 750. However, any alternate orientation that facilitates the proper flow of waste water in the septic tank 1000 will not conflict with the basic scope of this invention.

The pipes used to transport the waste water are four inches pipes in an exemplary embodiment. However, pipes of different sizes may be used without departing from the spirit of this invention.

Frame Guided Method-Pour

Once the foundation frames 450, sidewall frames 455, baffle frames 460, and headwall frames 475 have been erected and the projections 480 have been made (if applicable), then the concrete is poured per the process 150.

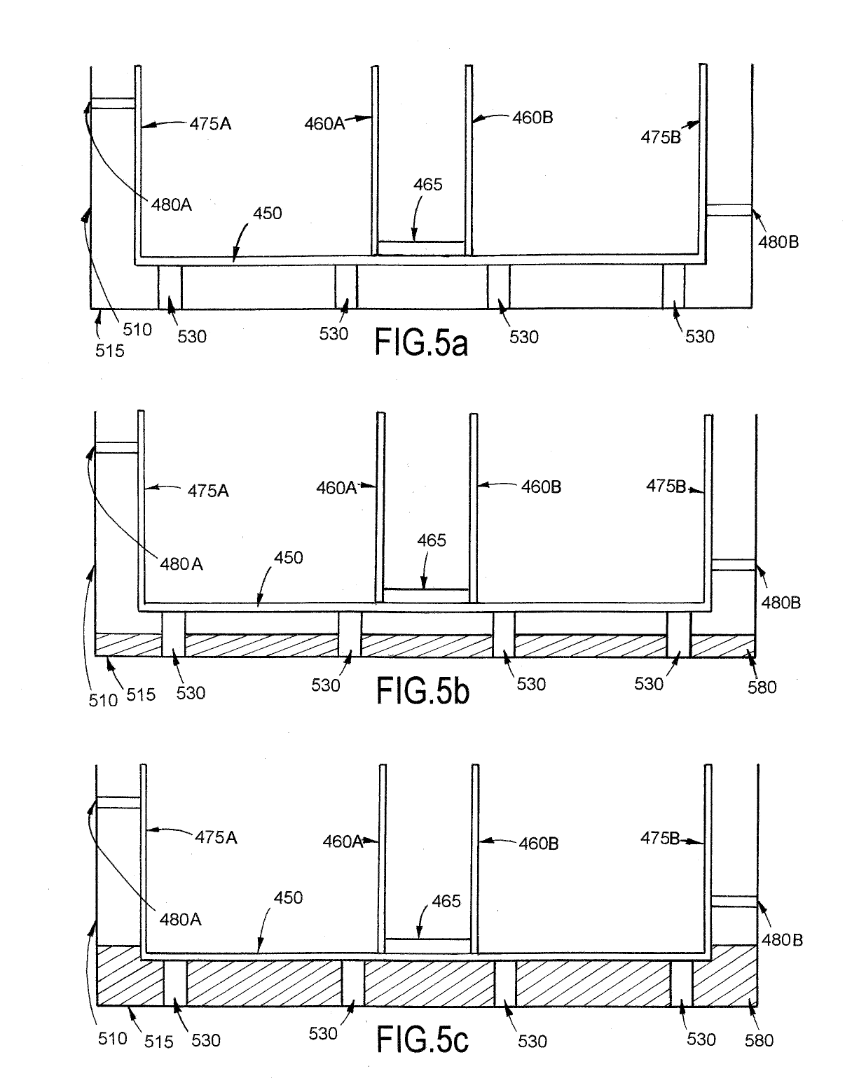

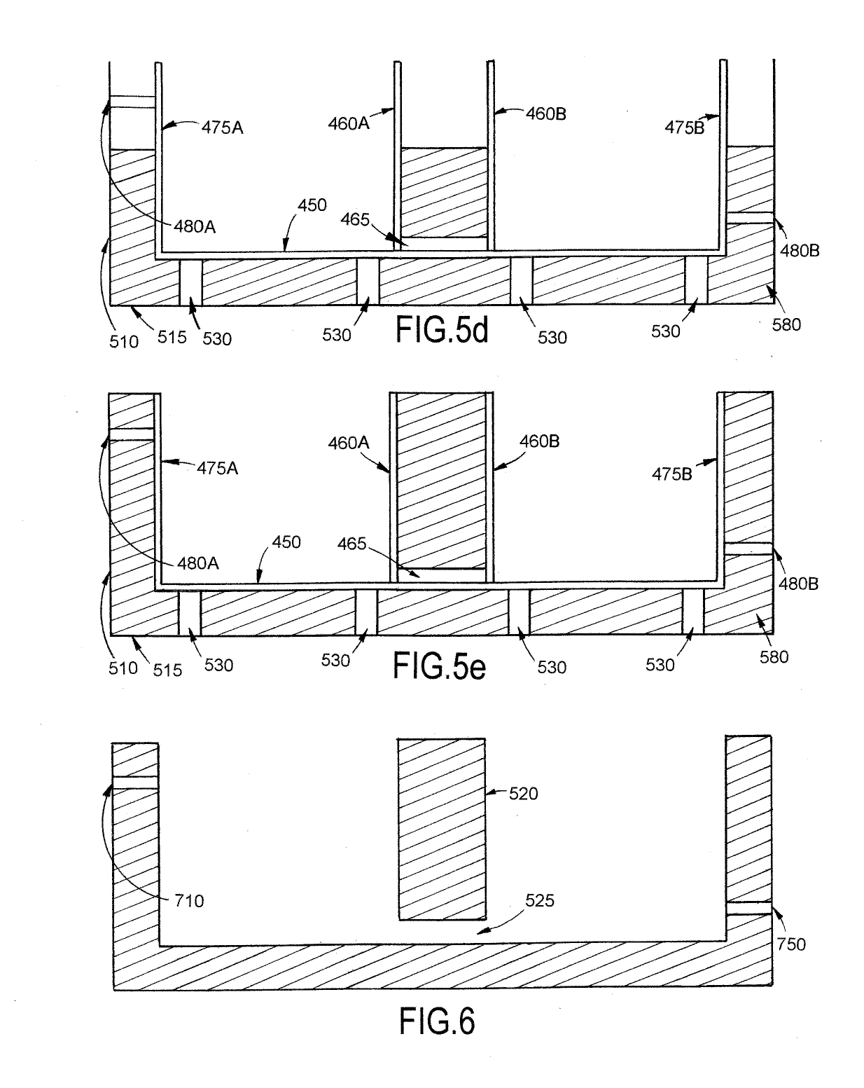

In the exemplary embodiments, the concrete is poured outside of the sidewall frames 455 and headwall frames 475 to form the sidewalls 1040 and headwalls 1030, and the excess concrete seeps beneath the foundation frame 450 to form the foundation 1050. The concrete beneath the foundation frame 450 from the sides will eventual meet to form a single uninterrupted piece of concrete in the foundation 1050. During this pour per the process 150, the concrete will also rise to fill in the areas between the sidewall frames 455 and the pit walls 510 to form the sidewalls 1040 and between the headwall frames 475 and the pit walls 510 to form headwalls 1030 as shown in FIGS. 5a-e. The concrete will also flow between the baffle frames 460 forming the baffle 520. This process is shown in FIGS. 5a-5e with an illustration of the concrete level 580 rising.

During the pouring process, the floating form 530 may be removed. In the exemplary embodiment, this may be accomplished by securing the sidewall frames 455, headwall frames 475, and baffle frames 460 in a manner that removes the need for them to be connected to the foundation frame 450. In an exemplary embodiment, a series of braces may be deployed that exerts a force on the sidewall frames 455 A, B, C, D that are across from each other, and the headwall frames 475 A, B across from the corresponding baffle frames 460 A, B as applicable per the process 155. The force these braces exert should be sufficient that they balance the force of the concrete pushing back on the braces. With the sidewall frames 455, headwall frames 475, and the baffle frames 460 now braced independent of the foundation frame 450, the foundation frame 450 may now be removed per the process 160. The sidewall frames 455, headwall frames 475, and the baffle frames 460 will be held in place until such time as the concrete forming the sides of the septic tank 1000 have hardened.

The removal of the foundation frame 450 now exposes the floating form 530. The floating forms 530 may now be removed from the base on the septic tank 1000. The concrete forming the base of the septic tank 1000 should not be set, but should have sufficient plasticity to substantially keep its shape once the floating forms 530 are removed. The openings in the base of the septic tank 1000 resulting from the removal of the floating forms 530 may now be filled with additional concrete that will fuse with the concrete in the base to form a single unit per the process 165.

Once the concrete hardens per the process 170, the braces holding the baffle frames 460, headwall frames 475, and sidewall frames 455 are removed per the process 175. The baffle frames 460, headwall frames 475, and sidewall frames 455 are then removed along with the blocking mold 465 per the process 180 shown in FIG. 6. The removal of the blocking mold 465 creates the baffle aperture 525. If a secondary frame 910 is used, it is removed as well. This process will make the foundation 1050, sidewalls 1040, headwalls 1030, and baffle 520 of the septic tank 1000 from a single piece of concrete.

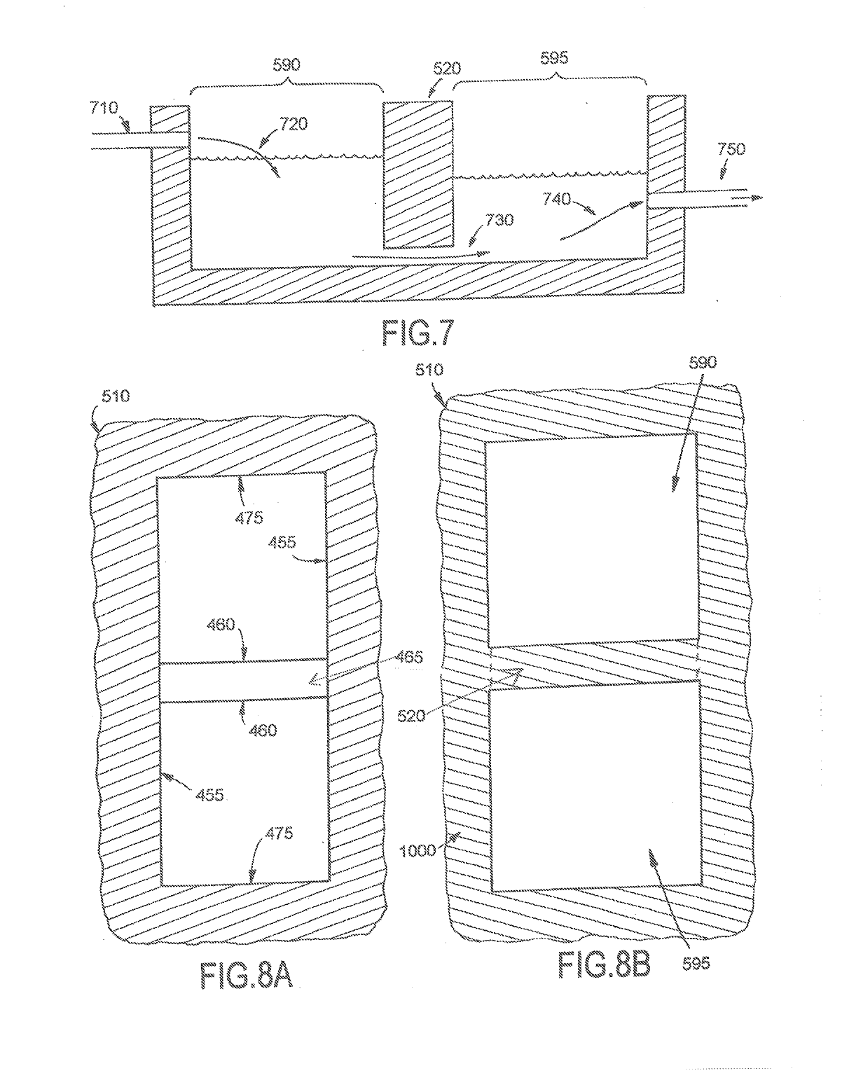

When the septic tank 1000 is in operation, waste water will come in through the inlet opening 710 where it will flow into the first chamber 590. The solid components will rest in the first chamber 590 while water flows 720 into the second chamber 595 as shown in FIG. 7. From the second chamber 595 the waste water will flow 740 to the outlet opening 750.

Mold Guided Method For Creation of Septic Tank

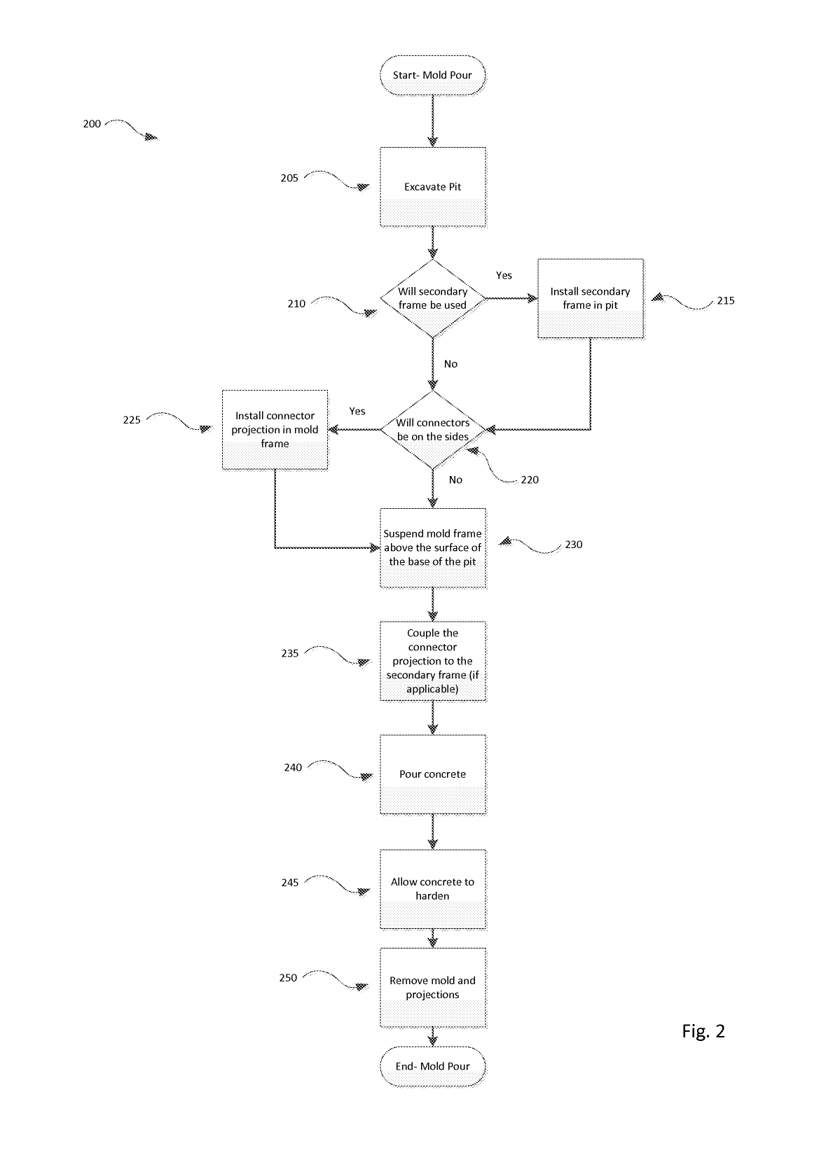

In an alternate embodiment show in FIG. 2, a mold frame 540 may be used to form a septic tank 1000. The mold frame 540 would appear to be two chamber molds 545 that are coupled together by a baffle connection 550 that is substantially similar to that of the blocking mold 465 from the previously disclosed embodiment. The mold frame 540 would appear to be a structure that has equivalent dimensions and displacement as the previously described system of foundation frame 450, baffle frame 460, sidewall frames 455, headwall frames 475, and blocking molds 465 as previously described. The width of the blocking mold 465 would be the same as the desired baffle 520 thickness. The two chamber molds 545 would accomplish substantially the same purpose as the foundation frames 450, sidewall frames 455, headwall frames 475, and baffle frames 460. The chamber molds 545 and baffle connection 550 also act substantially as the foundation frame 450 in the previously discussed embodiments. Further, while this embodiment may use a floating form 530 to keep the mold frame 540 above the pit bottom 515 as previously discussed, it may also be suspended above the pit bottom 515.

In an exemplary embodiment using a mold pour method 200, the pit may be excavated per the process 205 as in the previous embodiment. As in the previously disclosed embodiment, there is a choice to use a secondary frame 910 per the process 210.

Mold Guided Method-Mold Only

If the secondary frame 910 is not used, the mold frame 540 is suspended above the pit bottom 515 per the process 230. The mold frame 540 will be suspended in such a manner that there is sufficient space between the pit walls 510 and mold frame 540 to allow concrete be poured between the mold frame 540 and the pit walls 510 while at the same time allowing the concrete to flow between the pit bottom 515 and the bottom of the mold frame 540. As the concrete level rises, it will also fill in the space between the chamber molds 545, creating the baffle 520.

Mold Guided Method-Secondary Frame

If a secondary frame 910 is used, then it is to be installed in the pit per the process 215. To use the secondary frame method, the mold frame 540 is used as previously disclosed in the mold only method. A secondary frame 910 is then erected per the process 215 between the mold frame 540 and the pit walls 510. This allows the concrete to be poured as previously disclosed in the mold only method, but not to interact with the pit walls 510 directly. The secondary frame 910 runs parallel to the sides of the mold frame 540. The concrete is poured in the space between the mold frame 540 and the secondary frame 910. The formation of the sides of the septic tank 1000 as an integrated unit is achieved as in the mold only method, but the concrete flow is more carefully controlled. This also allows for builders to interface with the septic tank 1000 before it is covered without excavating more soil. If an above ground septic tank 1000 is built using a mold frame 540, this method maybe used.

Mold Guided Method-Openings

Septic tanks 1000 typically have at least one inlet opening 710 and one outlet opening 750. If the inlet openings 710 and outlet openings 750 are to be on the sides of the septic tank 1000 per the process 220, then the mold frame 540 (and secondary frame 910 as applicable) may further comprise projections 480 for the concrete to flow around so that the inlet openings 710 and outlet openings 750 may be maintained for connections. In an exemplary embodiment utilizing the mold only method, a removable projection 480 will be installed per the process 225 out of the mold frame 540 where the inlet openings 710 and outlet openings 750 are required. This projection 480 would extend far enough to make sure no concrete blocks the inlet opening 710 or outlet opening 750 when the concrete cures. If the secondary frame method is used per the process 210, then the projection 480 would connect the mold frame 540 and the secondary frame 910 at the desired inlet opening 710 and outlet opening 750 locations per the process 235. Once the concrete has been poured per the process 240 and sufficiently hardened, the projections 480 are to be removed to show the openings.

In an alternative embodiment, the actual inlet pipes and outlet pipes to be used by the septic tank 1000 may be used to form the inlet openings 710 and outlet openings 750 in the place of projections 480. The pipes may be installed, and the mold frame may be suspended adjacent to them. When the concrete is poured, the concrete will flow around the pipes, creating the openings necessary in the septic tank 1000 for access.

If the inlet openings 710 and outlet openings 750 will be on the top surface of the septic tank 1000, then none of these inlet openings 710 and outlet openings 750 will be needed in the sidewalls 1040 or headwalls 1030. The inlet openings 710 and outlet openings 750 may be part of the lid 1010, which will be discussed below.

The pipes used to transport the waste water are four inches pipes in an exemplary embodiment. However, pipes of different sizes may be used without departing from the spirit of this invention.

Mold Guided Method-Pour

Once the mold frame 540 has been suspended over the pit bottom 515 and the projections 480 have been made (if applicable), then the concrete is poured per the process 240.

In the exemplary embodiments, the concrete will flow until it completely fills the space between the mold frame 540 and the pit walls 510 (or secondary frame 910 if applicable). The concede flow will also fill the space between the pit bottom 515 and the mold frame 540. The space between the two chamber molds 545 would also be filled in to create the baffle 520. The mold frame 540 acts in substantially the same manner as the foundation frame 450, sidewall frames 455, and headwall frames 475 did in the single frame method described above. Once the concrete reaches sufficient hardness per the process 245, the mold frame 540 may be removed by decoupling the chamber molds 545 from the blocking mold 465 per the process 250. With both chamber molds 545 removed, the blocking mold 550 and the projections 480 would also be removed as well to allow access between the two chambers per the process 250. If a secondary frame 910 was used, then it is removed as well.

If this method is followed, the inlet pipes and outlet pipes may be connected for operations if the openings are in the sidewalls. The methods for allowing connections by removable projection 480 that are coupled to the frames are used as described in the frame guided pour method.

Lid Formation

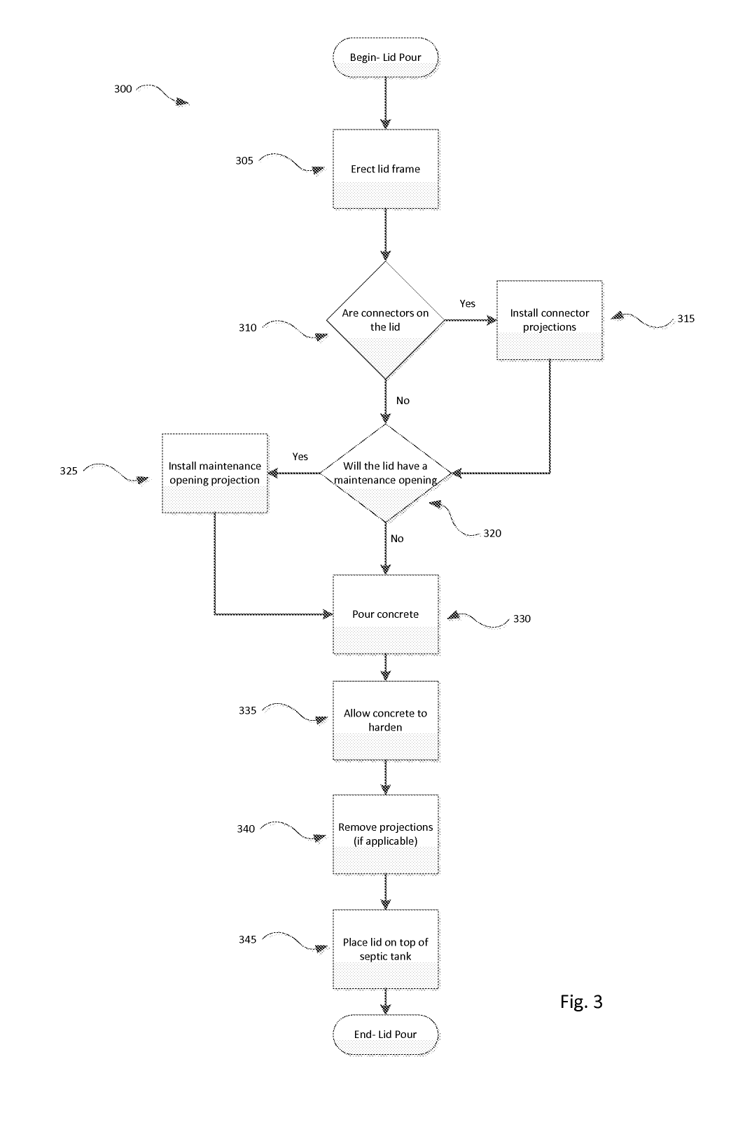

Once the foundation 1050, sidewalls 1040, headwalls 1030, and baffle 520 are set, the lid 1010 may be added. The lid 1010 may be a separate component that can be constructed on site and then placed on top of the open septic tank 1000 as shown in FIG. 3 300. The lid 1010 may be created by use of a lid mold, which is formed per a lid mold per the process 305.

The lid 1010 is not part of the septic tank 1000 as the lid itself is not necessary for operations therefore it can me formed from a different pour than the septic tank 1000 without departing from the scope and spirt of this invention.

Lid Formation-Openings

If the septic tank 1000 was designed to have the inlet openings 710 and outlet openings 750 in the lid 1010 per the process 310, then there may be projections 480 installed per the process 315 in the lid mold that allow inlet opening 710 and outlet opening 750 to be created in the lid 1010. Further, the lid frame may also allow for a utility opening per the process 320 (or clean out plug) in the lid 1010, per the process 325 so that the interior of the septic tank 1000 may be accessed for maintenance if needed. Once the concrete is poured per the process 330 and the lid 1010 has hardened per the process 335, the projections 480 may be removed per the process 340, opening up the applicable inlet openings 710, outlet openings 750, and maintenance openings 1020.

If this method is followed, the utility connection for the input pipes and outlet pipes may be connected for operations if the openings 1020 are in the lid 1010 once the lid 1010 is installed.

The lid 1010 may now be installed on top of the septic tank 1000 per the process 345.

Sealing Pour

In a further exemplary embodiment, once the septic tank 1000 is finished, an optional final pour may be used to fuse the septic tank 1000 and lid 1010 as single unit. In an exemplary embodiment, projections 480 are placed in the inlet opening 710, output opening 750, and utility opening 1020 (if applicable) to protect them during a final pour. The entire septic tank 1000 is then covered in a final pour, fusing the lid 1010 to the septic tank 1000. Any projections 480 are then removed to allow future access to the septic tank 1000. Alternatively, the actual connection pipes may be used in place of the projections 480 to make sure concrete does not block any openings.

Portable Frames

Some concrete septic tanks 1000 created by these exemplary methods will require frames to control the shape of the concrete before it becomes solid. While each septic tank 1000 may have frames constructed on site out of available materials, this may require frames to be built for each septic tank.

One option is to have a set of prefabricated frames available for use at each installation. However, there will need to be multiple frames for different sized projects. There may be standard sizes constructed, but the frames may not address the different sizes and numbers of connections needed for each septic tank 1000.

An alternate embodiment would be to have an adjustable frame that can extend or contract to different dimensions. The frame may have multiple removable projections 480 that can be used to create inlet openings 710 and outlet openings 750 as needed for the septic tank 1000. These frames may extend in the way of accordion like walls, may telescope laterally, or have multiple segments coupled together to become the desired length. Such a versatile frame would allow a single frame set to accommodate various project sizes.

In an exemplary embodiment, the frame would be an erectable structure capable of providing shape to a product made of a pourable castable material, comprising: a foundation element to define the base of said product, and a sidewall element to define the sidewalls of said product. In an additional exemplary embodiment, the erectable structure further comprises at least one projection to define an opening in said product. In an additional exemplary embodiment, the erectable structure further comprises a projection to define a baffle aperture in said product.

Additional Elements

While the disclosed embodiments have involved construction at the site of installation, it will be understood that these same procedures may be used to create a concrete septic tank 1000 at another location and transported to the final location. It is also understood that the resulting septic tank 1000 may be installed above ground. Additionally, all the disclosed methods will allow for the construction of a septic tank 1000 of sufficient strength to handle the stresses typically associated with septic tank 1000 operations. Further, this method may be modified to handle septic systems on a larger scale, including sewers.

Therefore, the foregoing is considered illustrative only of the principles of the invention. Further, since numerous modifications and changes will readily occur to those skilled in the art, it is not desired to limit the method to the exact steps and operations shown and described, and accordingly, all suitable modifications and equivalents may be resorted to, falling within the scope of the method.

1. A method for creating a septic tank, comprising:
forming a foundation,
forming at least one sidewall,
forming at least one headwall, and
forming a baffle,
wherein forming of said foundation, said at least one sidewall, said at least one headwall,
and said baffle occurs contemporaneously to form said septic tank, and
wherein said foundation, said at least one sidewall, said at least one headwall, and said
baffle are formed from a liquid castable material.

2. The method of claim 1, wherein said forming of said foundation, said at least one sidewall, said at least one headwall, and said baffle are accomplished substantially where said septic tank will be utilized.

3. The method of claim 1, wherein forming said foundation involves installing a foundation frame to control the placement of said liquid castable material to form said foundation.

4. The method of claim 1, wherein
forming said at least one sidewall involves installing at least one sidewall frame to control the placement of liquid castable material to form said at least one sidewall, and
forming said at least one headwall involves installing at least one headwall frame to control the placement of liquid castable material to form said at least one headwall.

5. The method of claim 4, wherein forming said at least one sidewall and at least one headwall involves installing a secondary frame to control the shape of said at least one sidewall and at least one headwall.

6. The method of claim 1, wherein forming said baffle involves installing a baffle frame to control the placement of said liquid castable material to form said baffle.

7. The method of claim 6, wherein forming said baffle further comprises installing a baffle mold to prevent said liquid castable material from occupying the location of a baffle aperture.

8. The method of claim 1, further comprising forming said baffle inside said septic tank.

9. The method of claim 8, further comprising installing a baffle frame to receive said liquid castable material to form said baffle.

10. The method of claim 1, wherein forming said at least one headwall further comprises the step of creating openings in said headwalls by using a projection to prevent said liquid castable material from occupying the space of said opening.

11. (canceled)

11. A method for creating a septic tank comprising:
erecting a secondary frame,
erecting a primary frame within said secondary frame, and
pouring a liquid castable material between said primary frame and said secondary frame,
wherein said primary frame is substantially detached from said secondary frame, allowing said liquid castable material to fill the resulting void between said secondary frame and said primary frame.

12. The method of claim 11, wherein said primary frame is removed once said liquid castable material hardens.

13. The method of claim 11, wherein said secondary frame is removed once said liquid castable material hardens.

14. A method for creating a septic tank comprising:
excavating a septic tank pit with a pit bottom and pit walls,
installing a foundation frame above said pit bottom,
installing at least one sidewall frame coupled to said foundation frame and adjacent to said pit walls,
installing at least one headwall frame coupled to said foundation frame and adjacent to said pit walls,
pouring a liquid castable material in the space between said pit walls and an area defined by said at least one sidewall frame and said at least one headwall frame, and
curing said liquid castable material,
wherein said at least one sidewall frame is coupled to said foundation frame allowing a sufficient distance between said sidewall frame and said pit walls to allow said liquid castable material to fill in to provide sufficient strength for said septic tank,
wherein said at least one headwall frame is coupled to said foundation frame allowing a sufficient distance between said at least one headwall frame and said pit walls to allow said liquid castable material to fill in to provide sufficient strength for said septic tank,
and
wherein said foundation frame is supported to rest at a sufficient height above said pit bottom to allow said liquid castable material to fill in to provide sufficient strength for said septic tank.

15. The method of claim 14, further comprising:
installing an secondary frame between said pit walls and said area defined by said at least one sidewall frame and said at least one headwall frame,
wherein said secondary frame is located a sufficient distance from said at least one sidewall frame and said at least one headwall frame to allow said liquid castable material to fill in to provide sufficient strength for said septic tank.

16. A septic tank which comprises a hollow structure with a baffle formed wherein said septic tank is formed by pouring of a castable material in one continuous session.

17. The septic tank of claim 16, wherein the interior dimensions of said septic tank shape is defined by a frame that controls said pouring of said castable material.

18. The septic tank of claim 16, wherein said septic tank further comprises at least one waste water inlet opening and at least one waste water outlet opening.

19. The septic tank of claim 18, wherein said at least one waste water inlet opening is located on an elevation higher than that of said at least one outlet opening.

20. The septic tank of claim 16, wherein said septic tank is produced at the site of installation.
